(19) United States
(12) Patent Application Publication
(10) Pub. No.: US 2018/0352295 A1
(43) Pub. Date: Dec. 6, 2018

(54) SYSTEM FOR TARGETING AND DEMOGRAPHICS

(71) Applicant: Sharp Kabushiki Kaisha, Sakai City, Osaka (JP)

(72) Inventor: SACHIN G. DESHPANDE, Camas, WA (US)

(21) Appl. No.: 15/571,816

(22) PCT Filed: Apr. 27, 2016
(86) PCT No.: PCT/JP2016/002218

§ 371 Date: Nov. 3, 2017

Related U.S. Application Data
(60) Provisional application No. 62/158,482, filed on May 7, 2015.

(51) Int. Cl. H04N 21/442; H04N 21/658

(52) U.S. Cl. CPC H04N 21/44222; H04N 21/6582

(57) ABSTRACT

A digital video device, comprising: a receiving information including a custom data field having an expiration related attribute, wherein the expiration related attribute indicates at which time the custom data field may be deleted, and a value of the expiration related attribute is capable to be changed at anytime under user control.

### TECHNICAL FIELD

The present invention relates a system for processing a digital service signal, and more particularly, to a system for processing a digital service signal for a personalization service.

### BACKGROUND ART

Along with developments of digital technologies, as digital broadcast services have been supplied, technologies for supplying higher-quality broadcast services are desirable.

Traditionally, broadcast providers have provided selected programs at selected times to the viewer. Traditionally such content is provided over-the-air or through a cable network to the viewer. The content being provided is preselected by the broadcast provider and the viewer needs to adjust their viewing schedule to accommodate that of the broadcast provider. Unfortunately, the viewer having to adjust their viewing schedule to accommodate that of the broadcast provider is undesirable.

Digital video devices, personal computers, televisions, and other video receiving devices permit the viewer to select desirable content for viewing. In many cases, the desirable content is recorded by the digital video devices for viewing at a later time. Many of the digital video devices include some rudimentary profiling capabilities that permit the viewer to select desirable content. Unfortunately, the profiling capabilities of such devices tend to be insufficient in selecting the most desirable content for the viewer.

### SUMMARY OF INVENTION

### Technical Problem

When content is rendered on a viewing device such as a Television, the user may prefer it to be rendered in a certain manner. For example a user may prefer the closed caption settings to be always on. Another user may prefer the closed caption settings to be always off. In yet another example a user may prefer Spanish audio language when available. In yet another example a user may prefer to use a “smooth” video de-noising filter for a particular channel which he knows transmits “grainy”/“noisy” video. Also the user may have a preference for certain kind of content. For example this may be preference for content which has a certain actor. Or it may be a preference for a certain Genre (e.g. Sports genre). This user preference for rendering may be called rendering preference or accessibility preference or content preference. Thus a flexible system which caters to multiple users indicating one or more preference values for one or more rendering/accessibility/content preference settings is desired.

What is desired, therefore, is a digital video device that includes an improved personalization preference system.

### Solution to Problem

According to the present invention, there is provided a digital video device, comprising: a receiving information including a custom data field having an expiration related attribute, wherein the expiration related attribute indicates at which time the custom data field may be deleted, and a value of the expiration related attribute is capable to be changed at anytime under user control.

### BRIEF DESCRIPTION OF DRAWINGS

FIG. 1 illustrates a digital broadcast system.

FIG. 2 illustrates a digital broadcast system.

FIG. 3 illustrates a preference system.

FIG. 4 illustrates an exemplary preference structure data fields.

FIG. 5 illustrates an exemplary preference structure data fields.

FIG. 6 illustrates an exemplary preference structure data fields.

FIG. 7 illustrates an exemplary preference structure data fields.

FIG. 8 illustrates an exemplary preference structure data fields.

FIG. 9 illustrates an exemplary preference structure data fields.

FIG. 10 illustrates an exemplary preference structure data fields.

FIG. 11 illustrates an exemplary preference structure data fields.

FIG. 12 illustrates exemplary personalization data fields.

FIG. 13 illustrates an exemplary XML schema for personalization data fields.

### DESCRIPTION OF EMBODIMENTS

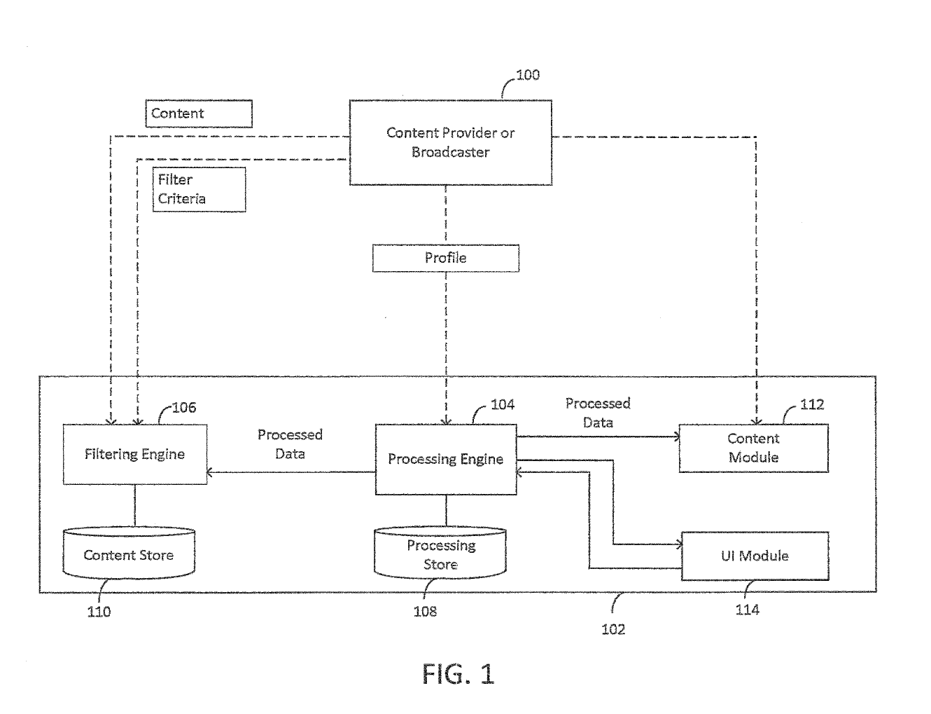

As illustrated in FIG. 1, a personalization broadcast system may include a content provider (or broadcaster) 100 and/or a receiver 102. The receiver 102 may include a processing engine 104, a filtering engine 106, a processing store 108, a content store 110, a content module 112, and/or a user interface (UI) module 114. The receiver 102 may receive content, etc. from the content provider 100. The structure of the aforementioned personalization broadcast system may be modified in any suitable manner, as desired.

The content provider 100 may transmit content, a profile, and/or filtering criteria to the receiver 102. Any other suitable data may be provided to the receiver 102 by the content provider 100. The profile and any other data, may be encapsulated in a data structure. The profile may include data related to profiles, demographics and interests, etc. of one or more users. The receiver 102 may process the content, the profile, any other data, and/or the filtering criteria, received from the content provider 100. Profile may include information regarding user preferences.

The processing engine 104 may receive the profile provided by the content provider 100. The processing engine 104 may transmit the profile to the UI module 114. When a user's input related to the profile occurs, the processing engine 104 may receive the user's input and other information from the UI module 114.

In addition, the processing engine 104 may update the profile data using the received user input. In particular, the processing engine 104 may delete, add, modify, and/or correct the profile data. In some cases the profile may be setup entirely on the receiver 102 without getting it from content provider or broadcaster 100. The profile may include information regarding user preferences. In addition, when another module requests the processing engine 104 to transmit profile data, the processing engine 104 may transmit profile data appropriate for the corresponding request to the corresponding module.

The filtering engine 106 may filter content according to the processed data (e.g., which may be the profile) and the filtering criteria. The filtering criteria refers to a set filtering criterions for filtering only contents appropriate for a user using the processed data. Alternatively, the filtering criteria refers to a set of filtering criterions for modifying contents for a user based on set profile or preference. The filtering engine 106 may receive the processed data from the processing engine 104 and receive the content and/or the filtering criteria from the content provider 100. Alternatively filtering engine 106 may receiver profile preferences from the processing engine 104 which is used to set or create filtering criterion. In this case, the content and/or the filtering criteria from the content provider 100 may not be received. In addition, when the convent provider 100 transmits a parameter related to content, the convent provider 100 may transmit a filtering criteria related to the content together. Then, the filtering engine 106 may match and compare the filtering criteria and the processed data and filter and download the content using the comparison result. The downloaded content may be stored in the content store 110.

The UI module 114 may display the processed data received from the processing engine 104 and receive data from the user. The UI module 114 may transmit the received user input to the processing engine 104.

The content module 112 may access the processing engine 104 to acquire processed data. In addition the content module 112 may receive content (e.g., data) provided by the content provider 100. The content may be content related to application executed by the receiver 102 and may include a declarative object (DO) such as a triggered declarative object (TDO). An application may be generally referred to as a declarative object. The term “Triggered Declarative Object” (TDO) may be used to designate a Declarative Object that has been launched by a trigger in a triggered interactive adjunct data service, or a declarative object that has been launched by a declarative object that has been launched by a trigger, and so on iteratively.

The content module 112 may access the processing store 108 to acquire the data related to a particular user. In this case, the content module 112 may use an application programming interface (API). The content module 112 may retrieve data from the processing store 108 using the API to acquire data related to a particular user. Then, the content module 112 may transmit the processed data, receive the processed data, and transmit the received processed data to the processing store 108 through the UI module 114. The processing store 108 may store the data related to a particular user. The content store 110 may store the filtered content.

The processing engine 104 may receive the profiles from the content provider 100. The receiver 102 may display profile received through the UI module 114 and receive data input from the user. The processing engine 104 may transmit processed data to the filtering engine 106. The filtering engine 106 may filter content through the processed data and the filtering criteria. Thus, the receiver 102 may provide the filtered content to the user to embody the personalization service. The receiver 102 may provide the processed data to the content provider 100, if desired. In this manner, the receiver 102 and/or the content provider 100 may modify the profile for the user, and the receiver 102 and/or the content provider 100 may use the profile to select appropriate content for the user.

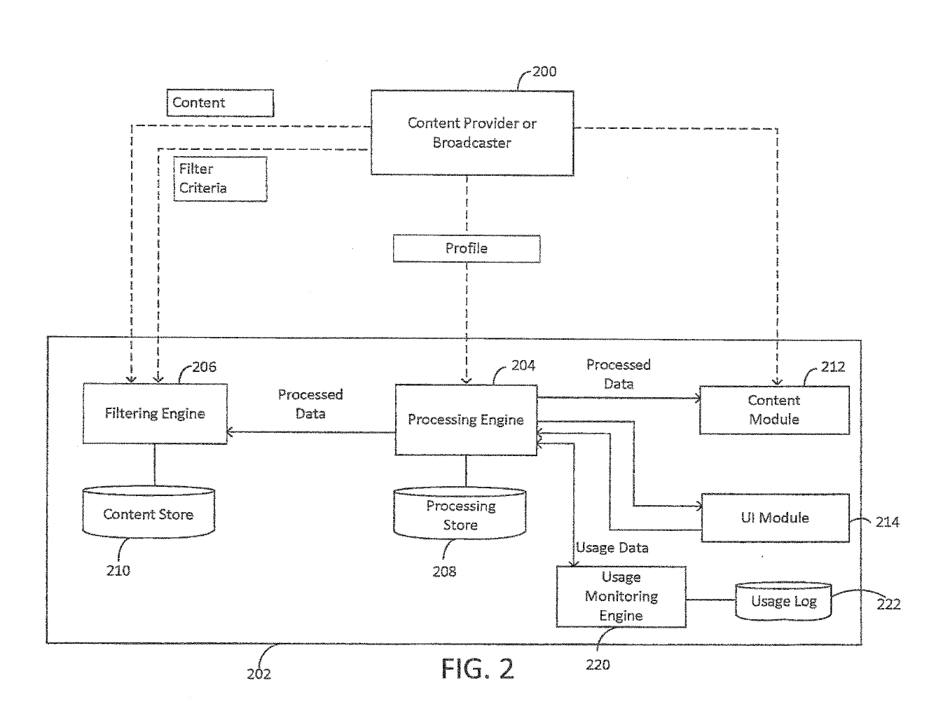

FIG. 2 is a diagram illustrating a digital broadcast system which illustrates an exemplary structure of a personalization broadcast system including a receiver for a personalization service. The personalization broadcast system may include a content provider (or broadcaster 200) and/or a receiver 202. The receiver 202 may include a processing engine 204, a filtering engine 206, a processing store 208, a content store 210, a content module 212, a UI module 214, a usage monitoring engine 220, and/or a usage log module 222. The receiver 202 may receive content, etc. from the content provider 200. The modules of FIG. 2 may be the same as the modules of FIG. 1, except that the broadcast system of FIG. 2 may further include the usage monitoring engine 220 and/or the usage log module 222.

The usage log module 222 may store information (or history information) regarding a broadcast service usage history of a user. The history information may include two or more usage data. The usage data refers to information regarding a broadcast service used by a user for a predetermined period of time. In detail, the usage data may include information indicating that news is watched for 40 minutes at 9 pm, information indicating a horror movie is downloaded at 11 pm, etc.

The usage monitoring engine 220 may continuously monitor a usage situation of a broadcast service of the user. Then, the usage monitoring engine 220 may delete, add, modify, and/or correct the usage data stored in the usage log module 222 using the monitoring result. In addition, the usage monitoring engine 220 may transmit the usage data to the processing engine 204 and the processing engine 204 may update the processed data using the transmitted usage data.

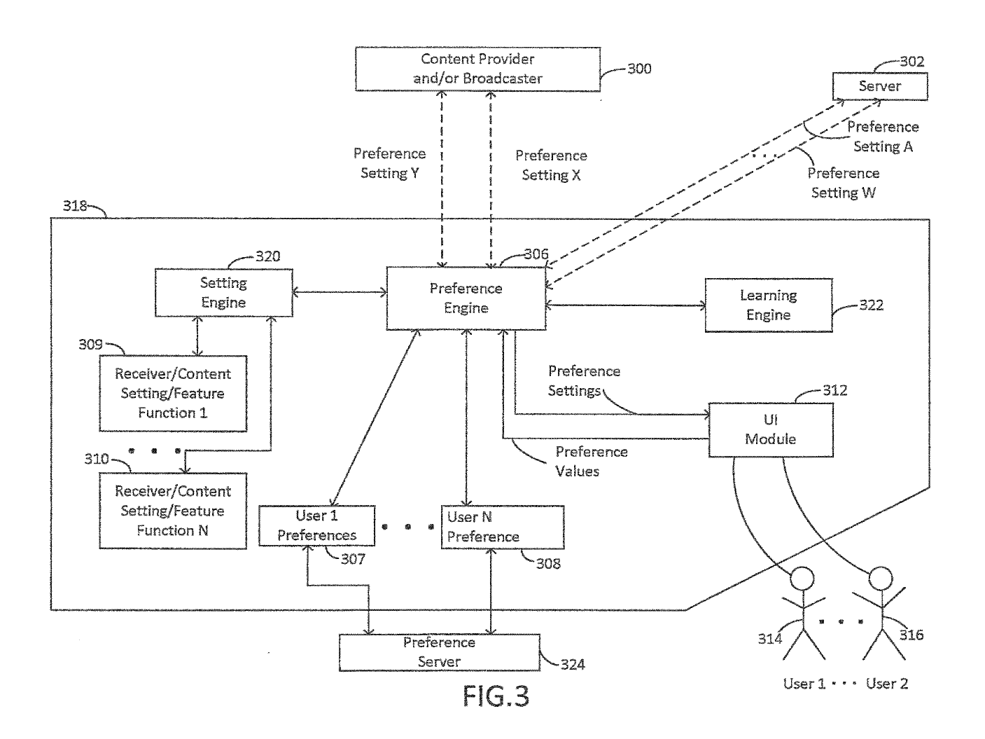

FIG. 3 illustrates an exemplary structure of a personalization preference system including a receiver for a personalization preference indication service. The personalization preference system may include a content provider (or broadcaster) 300 and/or a receiver 318. It should be noted that although FIG. 3 shows only one content provider (or broadcaster) 300, there could be multiple content providers (or broadcasters) similar to 300. The receiver 318 may include a preference engine 306, a setting engine 320, and/or a UI (i.e., user interface) module 312. The receiver 318 may receive preference setting X and preference setting Y from the content provider and/or broadcaster 300. The receiver 318 may receive one or more personalization data fields from the content provider and/or broadcaster 300. These may be received over a broadcast system, or some other means. In some embodiments some of the preference settings may be personalization data fields. Thus the term personalization data fields may include preference settings, targeting preferences, demographics preferences, etc. The receiver 318 may receive other preference settings A, . . . , preference setting W from a server 302. The receiver 318 may receive one or more personalization data fields from a server 302. These may be received over a network such as a broadband network. Or they may be received by some other means. The server 302 may be any type of a local server, a remote server, or a cloud server. In some cases the preference engine 306 may reside on a server such as server 302. Some of the modules of FIG. 3 may be the same as the modules of FIG. 1 and/or FIG. 2. In other case they may be different modules. The preference engine 306 may send one or more preference settings to the UI module 312. The UI module may display and/or show preference settings and/or personalization data fields and may get input from User 1 314, . . . , User N 316 or other users. Each user may set their preference value for selected preference settings. Each user may set their preference value for selected personalization data field. Separate preference values may be indicated for different users. Separate personalization data entry values may be indicated for different users for personalization data fields. The users may change and/or modify their preference values for a preference setting previously set. The preference engine 306 may store preference settings and/or values for each user. These may be stored as user 1 preferences 307, . . . , User N preferences 308. The preference engine 306 may store personalization data fields and personalization data entries for each user. These may be stored as user 1 personalization data fields and personalization data entry values, . . . , User N personalization data fields and personalization data entry values. In some cases the user preferences 307, 308 may be stored on a server outside the receiver 302. In some cases the user personalization data fields and personalization data entry values may be stored on a server outside the receiver 302. In some cases this may be the server 300. In other case it may be a separate server such as a preference server 324. In some cases some of the preference values and/or personalization data entry values for a user may be automatically learnt by the system such as by a learning engine 322. This may be based on monitoring user's behavior and learning what the user prefers. The setting engine 320 may obtain the preference settings and preference values for each of the users and may set a particular setting on the receiver 318 according to the preference value indicated by the user. The setting engine 320 may obtain the personalization data fields and personalization data entry values for each of the users and may set a particular setting on the receiver 318 according to the personalization data entry value indicated by the user. The preference setting may be related to receiver settings and/or content settings (such as 309, 310). The personalization data fields and personalization data entry values may be related to targeting and/or demographics. In one case, the preference setting may be a receiver setting such as a “preferred brightness” of the receiver. In another case, the preference setting may be a content setting, related to setting the content's closed captioning “ON” or “OFF”. In another example, a preference setting may be a “preferred audio language” and the preference value for user 1 may be “English” and for user 2 may be “Spanish”. Then the setting engine 320 may set the audio language for the content being watched to “English” when user 1 is viewing the content and to “Spanish” when user 2 is viewing the content.

In one case a personalization data field may be user age and personalization data entry value for this field may be age “54”. In another case a personalization data filed may be user sex as male or female and the personalization data entry value for this field may be “female”. In yet another case a personalization data field may be user's income range and personalization data entry value for this field may be US dollars “20,000-30,000” as the income range.

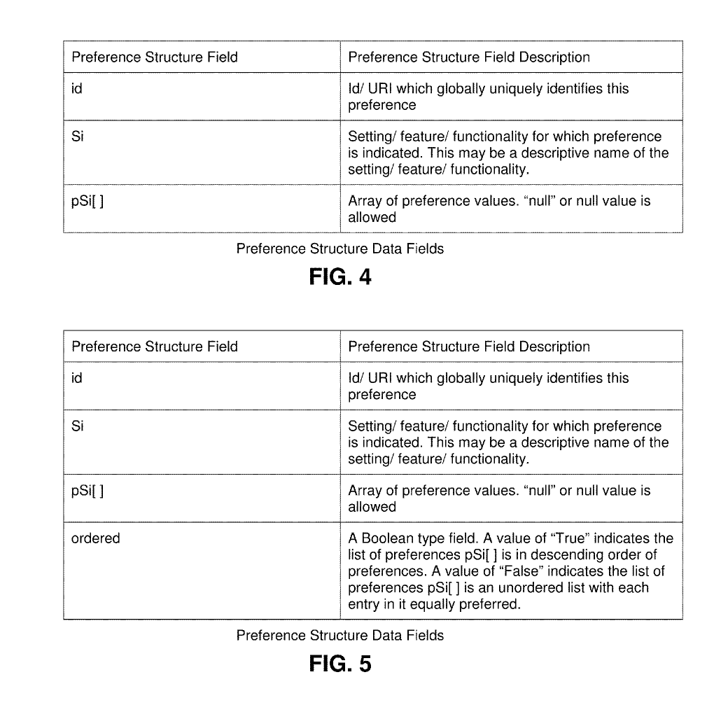

Referring to FIG. 4, the profile may include, at least in part, preference structure data fields. The preferences may be used, for example, as the basis for rendering content for the user (e.g., sometimes referred to as accessibility preferences or rendering preferences or content preferences). The preference structure data table may include a preference structure field. One of the preference structure fields may include an “id” which refers to an identification and/or a uniform resource identifier (e.g., URI) which may be a string of characters used to identify a name of a resource. Such identifications may enable interactions with representations of the resource over a network, typically the World Wide Web, using specific protocols. It may also enable interaction over local area network, wide area network, cellular network and/or home network. Schemes specifying a syntax and associated protocols define each URI. Another of the preference structure fields may include a “Si” field which refers to a setting, feature, content and/or functionality for which a preference is indicated. A setting, for example, may be indicated as setting 1 by S1, a setting 2 by S2, etc. A setting, for example, may be indicated by S[i]. For example, this may be a descriptive name of the setting, feature, content and/or functionality. For example, the Si may indicate a preference for the audio language (e.g. Spanish language, English language, etc.), a preference for number of audio channels (e.g. 2-channel audio, a preference for 5.1-channel audio, etc.), a preference for video resolution (e.g. standard definition, high definition, 4K ultra high definition, etc.) a preference for 2-dimensional or 3-dimensional video, a preference for closed captions (e.g. on, off). A unique identifier associated with a setting Si may be indicated as id[Si]. Another of the preference structure fields may include “pSi[ ]” which refers to an array of preference values, including “null” or null value. In this manner, more than one value may be indicated for a particular setting Si. A preference value may be indicated (e.g. by user or default value set by system) for a setting Si with an id[Si] as a list of elements pSi[0], . . . pSi[j], . . . , pSi[Ni−1] with list length of Ni. Data type for each of the elements in the list may be dSi. Alternatively, the preference value pSi[j] may be denoted as p[Si][j]. Alternatively, the data type dSi may instead be denoted as d[Si]. The current value for a setting/feature/functionality/content Si which may have been set based on the preference indicated may be denoted as v(Si). In this manner, depending on the available content the profile may set the setting Si to the value v(Si). Thus what is going to be rendered is different than the preference (e.g., pSi[ ]). For example, if the user's preference is for a Spanish language track, but the only available track is an English language track, the rendering will be indicated as English despite the preference being for Spanish. In this case Si is “audio language track” or “preferred audio language”, pSi is “Spanish” and v(si) is “English”. The data structure consisting of preference value indication for Si, with unique identifier id[Si], and preference values indicated pSi[0], . . . pSi[j], . . . , pSi[Ni−1] may be denoted as PrefStruct[i], which may be generally referred to as a “preference indicator” structure.

As illustrated in FIG. 4, the preference structure may be represented in an XML format. An example XML schema for the preference structure data fields of FIG. 4 is as follows:

```
<?xml version=“1.0” encoding=“UTF-8”?>
<xs:schema xmlns:xs=“http://www.w3.org/2001/XMLSchema” >
<xs:element name=“PrefStructTable” type=“PrefStructTableType” />
<xs:complexType name=“PrefStructTableType”>
<xs:sequence>
<xs:element name=“PrefStruct” type=“PrefStructType” minOccurs=“0”
maxOccurs=“unbounded”/>
</xs:sequence>
</xs:complexType>
<xs:complexType name=“PrefStructType”>
<xs:sequence>
                  <xs:element name=“id” type=“xs:anyURI”/>
                  <xs:element name=“si” type=“xs:string”/>
                  <xs:element name=“pSi” type=“StringArrType”
minOccurs=“0” maxOccurs=“unbounded”/>
</xs:sequence>
</xs:complexType>
<xs:simpleType name=“StringArrType”>
      <xs:list itemType=“xs:string”/>
</xs:simpleType>
</xs:schema>
```

In another case the preference structure data fields may be represented by JavaScript Object Notation (JSON).

By way of example, the system may enable the use of personalization criteria that are defined by individual entities to meet their unique needs.

By way of example, the system may enable the use of common personalization criteria that are shared among multiple entities (so users do not need to provide the same input multiple times).

By way of example, the system may enable consumer privacy and protection of consumer data at least to a level of compliance with applicable federal, state, and local privacy laws.

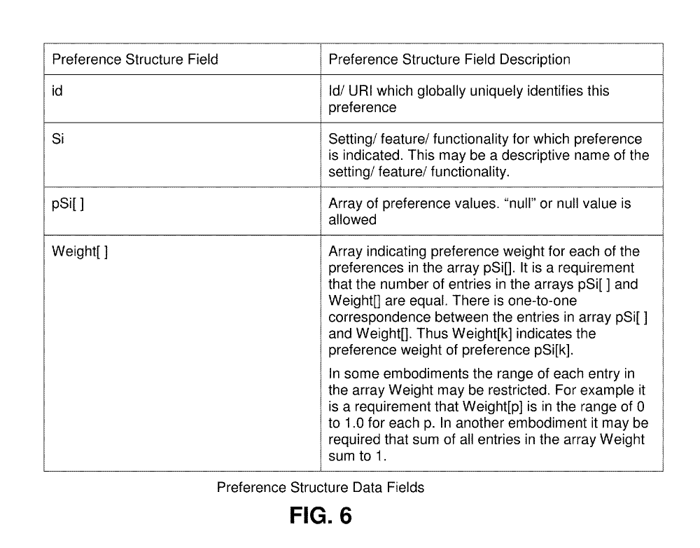

Referring to FIG. 5 and FIG. 6, the preference values for a particular setting may be indicated with an ordering and/or weighting, to provide additional flexibility in the selection mechanism for desirable rendering. For example, the list of preferences may be indicated as ordered list or unordered list. For example this could be done by including a 1 bit flag (e.g. Boolean field “Ordered” which takes the value “True” to indicate an ordered list and value “False” to indicate an unordered list) which indicates if the list is ordered or unordered (or vice versa). An ordered list means that an earlier element in the list is preferred more compared to a later element in the list (or vice versa). An unordered list means that each element in the list is equally preferred.

Alternatively/additionally a weighting may be provided for each preference value. Thus optionally a weight may be assigned to one or more or all elements in the preference list. For example, weights in the range [0,1] may be assigned to each element in the list with higher weight indicating more preference (or vice versa). In this manner a suitable weight may be assigned to each element in the list to provide a weighted ordering. Also, assigning equal weight to each element permits the formation of what is equivalently an unordered and/or equal preference list.

An example, illustrating one application of the aforementioned ordering and/or weighting of preferences is as follows. Jane is fluent in English and Spanish language and has equal preference for her audio language. Jane sets an unordered list of preference (or equal weighted list of preference) for audio track language to English and Spanish. Additionally Jane has set an ordered list of preference for “number of audio channels ” as “5.1 channel audio” followed by “stereo audio”. For a program she is watching which is broadcast in Spanish audio with 5.1 channels and in English with 2.0 channels, she is automatically presented with Spanish 5.1 audio track. In this case for the setting “audio track language” (setting Sa, with id[Sa]) Jane sets a preference (pSa[0]) of “English” and second preference(pSa[1]) of “Spanish” either as a unordered list (e.g. Boolean “Ordered” set to “False”), or as a weighted list with weights equal to 1.0 for each of “English” and “Spanish” entries. Additionally for the setting “Audio channels” (setting Sc, with id[Sc]) Jane sets a preference (pSc[0]) of “5.1 channels” and second preference(pSc[1]) of “2.0 channels” as an ordered list (e.g. Boolean “Ordered” set to “True”).

By way example, the aforementioned example may include an ordering modification. The list of preferences can be indicated as ordered list or unordered list. For example the modification may include a 1 bit Boolean field “Ordered” which takes the value “True” to indicate an ordered list of preference values and value “False” to indicate an unordered list of preference values. An ordered list means that an earlier element in the list is more preferred compared to a later element in the list. An unordered list means that each element in the list is equally preferred.

By way example, the aforementioned example may include an weighting modification. A weight may be assigned to each element in the preference list. For example weights in the range [0,1] could be assigned to each element in the list with higher weight indicating more preference. In this case suitable weights may be assigned to each element in the list to create a weighted ordering. The weighting may be signaled only if the list is an “Ordered” list.

As illustrated in FIG. 5, the preference structure including conditions and an ordering related field may be represented in an XML format. An example XML schema for the preference structure data fields including ordering information of FIG. 5 is as follows:

```
<?xml version=“1.0” encoding=“UTF-8”?>
<xs:schema xmlns:xs=“http://www.w3.org/2001/XMLSchema” >
<xs:element name=“PrefStructTable” type=“PrefStructTableType” />
<xs:complexType name=“PrefStructTableType”>
<xs:sequence>
<xs:element name=“PrefStruct” type=“PrefStructType” minOccurs=“0”
maxOccurs=“unbounded”/>
</xs:sequence>
</xs:complexType>
<xs:complexType name=“PrefStructType”>
<xs:sequence>
                  <xs:element name=“id” type=“xs:anyURI”/>
                  <xs:element name=“si” type=“xs:string”/>
                  <xs:element name=“pSi” type=“StringArrType”
minOccurs=“0” maxOccurs=“unbounded”/>
                  <xs:element name=“Ordered” type=“xs:boolean”/>
</xs:sequence>
</xs:complexType>
<xs:simpleType name=“StringArrType”>
      <xs:list itemType=“xs:string”/>
</xs:simpleType>
<xs:simpleType name=“IdArrType”>
      <xs:list itemType=“xs:anyURI”/>
</xs:simpleType>
</xs:schema>
```

In another case the preference structure data fields may be represented by JavaScript Object Notation (JSON).

As illustrated in FIG. 6, the preference structure including conditions and a weighting related field may be represented in XML format. An example XML schema for the preference structure data fields including weighting information of FIG. 6 is as follows:

```
<?xml version=“1.0” encoding=“UTF-8”?>
<xs:schema xmlns:xs=“http://www.w3.org/2001/XMLSchema” >
<xs:element name=“PrefStructTable” type=“PrefStructTableType” />
<xs:complexType name=“PrefStructTableType”>
<xs:sequence>
<xs:element name=“PrefStruct” type=“PrefStructType” minOccurs=“0”
maxOccurs=“unbounded”/>
</xs:sequence>
</xs:complexType>
<xs:complexType name=“PrefStructType”>
<xs:sequence>
                  <xs:element name=“id” type=“xs:anyURI”/>
                  <xs:element name=“si” type=“xs:string”/>
                  <xs:element name=“pSi” type=“StringArrType”
minOccurs=“0” maxOccurs=“unbounded”/>
                  <xs:element name=“Weight” type=“FloatArrType”
            minOccurs=“0” maxOccurs=“unbounded”/></xs:sequence>
</xs:complexType>
<xs:simpleType name=“StringArrType”>
      <xs:list itemType=“xs:string”/>
</xs:simpleType>
<xs:simpleType name=“IdArrType”>
      <xs:list itemType=“xs:anyURI”/>
</xs:simpleType>
<xs:simpleType name=“FloatArrType”>
      <xs:list itemType=“xs:float”/>
</xs:simpleType>
</xs:schema>
```

In another case the preference structure data fields may be represented by JavaScript Object Notation (JSON).

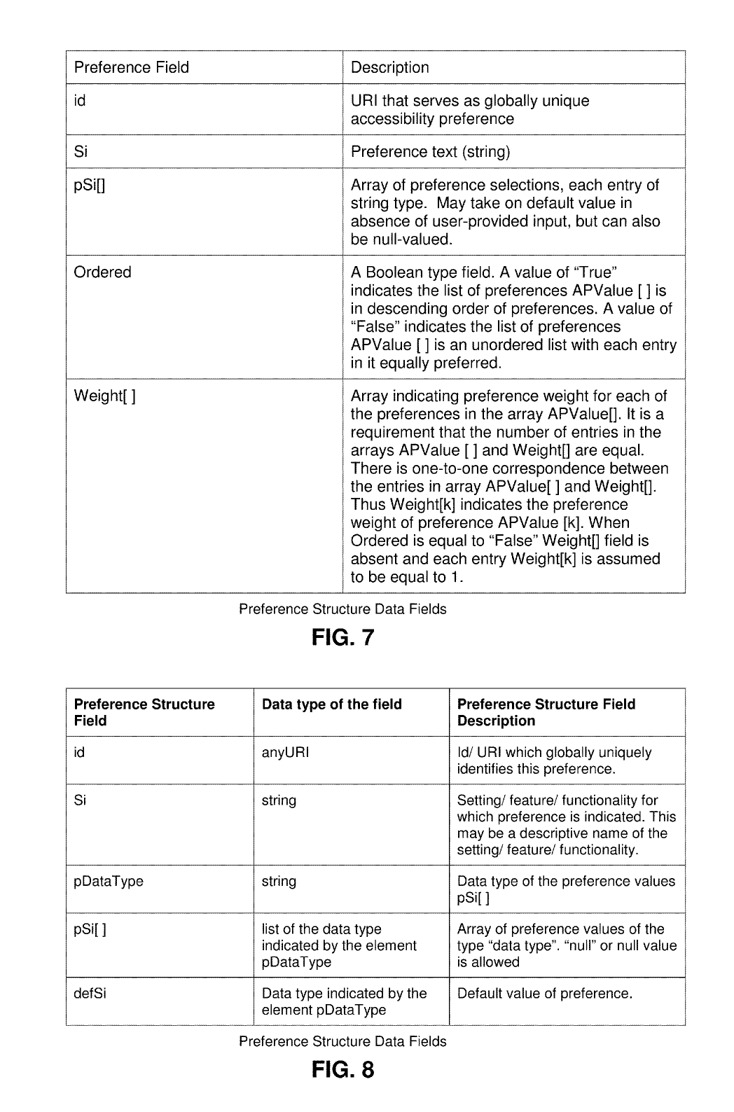

Referring to FIG. 7, in another embodiment, both ordered and weight elements may be included in the preference structure in XML format. An example XML schema for the preference structure data fields of FIG. 7 is as follows:

```
<?xml version=“1.0” encoding=“UTF-8”?>
<xs:schema xmlns:xs=“http://www.w3.org/2001/XMLSchema” >
<xs:element name=“PrefStructTable” type=“PrefStructTableType” />
<xs:complexType name=“PrefStructTableType”>
<xs:sequence>
<xs:element name=“PrefStruct” type=“PrefStructType” minOccurs=“0”
maxOccurs=“unbounded”/>
</xs:sequence>
</xs:complexType>
<xs:complexType name=“PrefStructType”>
<xs:sequence>
                  <xs:element name=“id” type=“xs:anyURI”/>
                  <xs:element name=“si” type=“xs:string”/>
                  <xs:element name=“pSi” type=“StringArrType”
minOccurs=“0” maxOccurs=“unbounded”/>
                  <xs:element name=“Ordered” type=“xs:boolean”/>
                  <xs:element name=“Weight” type=“FloatArrType”
minOccurs=“0” maxOccurs=“unbounded”/>
</xs:sequence>
</xs:complexType>
<xs:simpleType name=“StringArrType”>
      <xs:list itemType=“xs:string”/>
</xs:simpleType>
<xs:simpleType name=“IdArrType”>
      <xs:list itemType=“xs:anyURI”/>
</xs:simpleType>
<xs:simpleType name=“FloatArrType”>
      <xs:list itemType=“xs:float”/>
</xs:simpleType>
</xs:schema>
```

In another case the preference structure data fields may be represented by JavaScript Object Notation (JSON).

Referring to FIG. 8, there may be a data type indication for the preference values. Instead of requiring all preference values to be of the string type, it is preferable that the data type of a preference value is indicated in the accessibility preference table. In particular, it is desirable to define the list of multiple allowable data types.

Certain preference values may be indicated by a Boolean data type. For example “Closed Caption On” setting's preference could take a value of “True” or “False”. Certain other settings could be indicated by an integer data type. For example the “Preferred Loudness” setting may be set within a value range of [0,100]. Certain other settings may be more complicated and may be represented via String data type. For example “Video de-noising filter” may be set to a value of “Soft” or “Crisp”.

A limited number of data types may be defined for indicating preference values. As an example if XML format is chosen for representing preference value data then the data types that can be supported for the preference value field could include one or more of the following: (1) byte; (2) unsigned byte; (3) short; (4) unsigned short; (5) int; (6) unsigned int; (7) long; (8) unsigned long; (9) decimal; (10) string; (11) float; (12) double; (13) time; (14) date; (15) dateTime; (16) duration; (17) boolean; and/or (18) anyURI.

Other additional data type may be defined or some of the above data types may not be defined.

If JavaScript Object Notation (JSON) is used for representing the preference value data then the data types that may be supported for the preference value field may include, for example, the following: (1) array: A JSON array; (2) boolean: a JSON Boolean; (3) integer: a JSON number without a fraction or exponent part; (4) number: any JSON number, where number includes integer; (5) null: the JSON null value; (6) object: a JSON object; and/or (7) string: a JSON string.

Other additional data type may be defined or some of the above data types may not be defined.

As illustrated in FIG. 8, the preference structure data type indications related field may be represented in XML format. An example XML schema for the preference structure data fields of FIG. 8 is as follows:

```
<?xml version=“1.0” encoding=“UTF-8”?>
<xs:schema xmlns:xs=“http://www.w3.org/2001/XMLSchema” >
<xs:element name=“PrefStructTable” type=“PrefStructTableType” />
<xs:complexType name=“PrefStructTableType”>
<xs:sequence>
<xs:element name=“PrefStruct” type=“PrefStructType” minOccurs=“0”
maxOccurs=“unbounded”/>
</xs:sequence>
</xs:complexType>
<xs:complexType name=“PrefStructType”>
<xs:sequence>
                  <xs:element name=“id” type=“xs:anyURI”/>
                  <xs:element name=“si” type=“xs:string”/>
                  <xs:element name=“pDataType” type=“xs:string”/>
                  <xs:element name=“pSi” type=“StringArrType”
minOccurs=“0” maxOccurs=“unbounded”/>
                  <xs:element name=“defSi” type=“xs:string”
                  minOccurs=“0”
maxOccurs=“1”/>
</xs:sequence>
</xs:complexType>
<xs:simpleType name=“StringArrType”>
      <xs:list itemType=“xs:string”/>
</xs:simpleType>
<xs:simpleType name=“IdArrType”>
      <xs:list itemType=“xs:anyURI”/>
</xs:simpleType>
<xs:simpleType name=“FloatArrType”>
      <xs:list itemType=“xs:float”/>
</xs:simpleType>
</xs:schema>
```

An example XML data conforming to the schema is illustrated below:

```
<?xml version=“1.0” encoding=“UTF-8”?>
<PrefStructTable
xmlns:xsi=“http://www.w3.org/2001/XMLSchema-instance”
        xsi:noNamespaceSchemaLocation=“accesspref1.xsd”>
      <PrefStruct>
            <id>pref://456</id>
            <si>ClosedCaption</si>
            <pDataType>String</pDataType>
            <pSi>ON</pSi>
            <defSi>OFF</defSi>
      </PrefStruct>
</PrefStructTable>
```

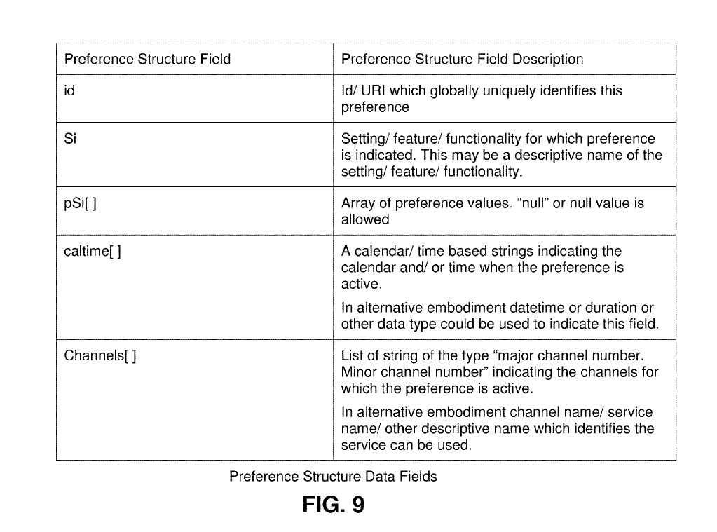

Referring to FIG. 9, it is desirable to include particular preferences relevant to a calendar/time based and/or a service/channel based service. It is desirable that each preference field (or selected ones) may set a calendar/time based field for which the preference is active. When such a field is not set for a preference then the preference is independent of the calendar/time.

The examples of calendar/time based preferences may include, for example, the following: (1) Everyday from 8 PM to 11 PM (e.g. during prime time); (2) Every weekday from 7 AM to 9 AM; and/or (3) Every weekend from 10 AM to 11 PM. A special value of “ANY” may be defined to indicate that the preference setting is applied all the time. OR if the calendar/time based field is not present or is set to null then it may indicate that the preference is applied preference setting is applied all the time. Additionally preferences may be individually associated and set for each service and/or channel(s).

For example, this may be a list of Major channel number and Minor channel number that may be included in each preference structure. If such a list exists for a preference structure then the preference is preferably only applicable to the channels in the list. If such a list does not exists (e.g. is set to a special value such as value of “null”) then the preference preferably applies to all the channels/programs.

Alternatively a special value of “ANY” may be defined to indicate that the setting is applied to any channel. In another embodiment preferences may be specifically applied to one or more of: (1) Program(s) (each with a unique program identifier); (2) Shows(s) (each with a unique show identifier); (3) Segment(s) (each with a unique segment identifier); (4) Genre(s) (each with a unique genre ID, e.g. when it is “Sports” genre).

The calendar/time based and/or service/channel based preference indication may be signaled via a condition (e.g. “cond”) field described later. An example illustrating the use of one embodiment of the calendar/time based and/or service/channel based preferences is described as follows: John prefers English language audio track for his programs. He is learning Spanish language and every weekday in the evening from 10 PM to 11 PM when he listens to the “sports center summary” he prefers to set the language to Spanish. In this case for the preference setting “audio track language” a preference value of “Spanish” with calendar/time setting set to “Every weekday from 10 PM to 11 PM” can be set. His default preference value for “audio track language” is set to “English”.

As illustrated in FIG. 9, the preference structure calendar/time based and/or service/channel based fields may be represented in XML format. An example XML schema for the preference structure data fields of FIG. 9 is as follows:

```
<?xml version=“1.0” encoding=“UTF-8”?>
<xs:schema xmlns:xs=“http://www.w3.org/2001/XMLSchema” >
<xs:element name=“PrefStructTable” type=“PrefStructTableType” />
<xs:complexType name=“PrefStructTableType”>
<xs:sequence>
<xs:element name=“PrefStruct” type=“PrefStructType” minOccurs=“0”
maxOccurs=“unbounded”/>
</xs:sequence>
</xs:complexType>
<xs:complexType name=“PrefStructType”>
<xs:sequence>
                  <xs:element name=“id” type=“xs:anyURI”/>
                  <xs:element name=“si” type=“xs:string”/>
                  <xs:element name=“pSi” type=“StringArrType”
minOccurs=“0” maxOccurs=“unbounded”/>
                  <xs:element name=“caltime” type=“StringArrType”
minOccurs=“0” maxOccurs=“unbounded”/>
                  <xs:element name=“Channels”
type=“StringArrType” minOccurs=“0” maxOccurs=“unbounded”/>
</xs:sequence>
</xs:complexType>
<xs:simpleType name=“StringArrType”>
      <xs:list itemType=“xs:string”/>
</xs:simpleType>
<xs:simpleType name=“IdArrType”>
      <xs:list itemType=“xs:anyURI”/>
</xs:simpleType>
</xs:schema>
```

In some embodiments some of the XML elements or sub-elements may instead be signaled as attributes.

In some embodiments some of the XML attributes may instead be signaled as elements or sub-elements.

Referring again to FIG. 4, in each preference indicator structure one or more conditions may be indicated. These conditions may be met before indicated preference values for this setting are evaluated and activated. In one embodiment only one such condition may be allowed. This can be accomplished as follows. A preference indicator structure PrefStruct[i] with unique identifier id[Si] can include a reference to one or more other preference indicator structures, e.g. id[Sa], id[Sp], . . . In this case before evaluating this preference structure PrefStruct[i], the preference structures PrefStruct[a] corresponding to setting with id id[Sa] and PrefStruct[p] corresponding to setting with id id[Sp] may be evaluated and the preference setting value for them may be activated. For example in one case the activation may mean that the setting Sa is set to value pSa[0] and setting Sp is set to value pSp[0]. In other embodiments, multiple such conditions may be allowed.

A condition to check the current active value for one or more other settings may be indicated. And the current setting being evaluated may be assigned the preferred value only if the current active value of another setting is equal to a specified value. In one embodiment the preference for setting Si may be evaluated if the current value of setting Sa, i.e. v(Sa) is equal to a specified value V. In one embodiment in this case a default value for setting Si may always be indicated and may be the value the setting is set to if the specified condition of v(Sa) is equal to V is not met. In another embodiment the preference value for setting Si may be indicated for each of the conditions separately as separate preference structure entries. In this case, for example, (1) multiple preference structures may be included for the same setting but each preference structure may have a different condition; and (2) typically the condition in one preference structure for setting Si will be complementary of the condition in the other preference structure for the same setting Si. For example in one preference structure Si the condition will be “Is current value of setting Sa equal to V”, which may be represented as if(v(Sa)==V). Then in the another complementary structure for Si the condition will be “Is current value of setting Sa not equal to V”, which may be represented as if(v(Sa)!=V). Since at least one of the two conditions are true (i.e. v(Sa) is either equal to V or not equal to V) the preference setting Si will always have a preference value assigned to it from one of the two preference structures.

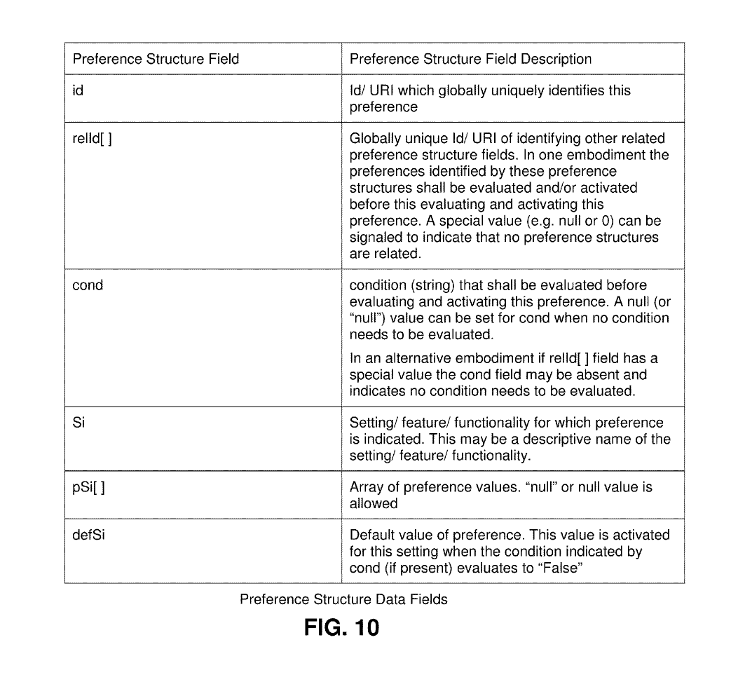

Thus in this case an ordering is defined regarding which preference setting should be evaluated first and which preference setting should be evaluated after that. In general all the preferences settings which are needed for condition checking of a current setting need to be evaluated (and set or activated) before evaluating the current setting. In general such an ordering may also be indicated without requiring a condition evaluation. Thus a setting Sa may list settings Sb, Sc, Sx to be evaluated (and set or activated) prior to evaluating and setting/activating Sa. Then the setting Sb may list other settings Sz, Sy which needs to be evaluated (and set) prior to evaluating and setting Sb. This establishes an order in which preference settings may be evaluated and set. For example by using the rend field shown in FIG. 10 intends to describe a preference structure which imposes such an ordering on the evaluation and setting preferences.

In some cases when such an ordering of preference structures is described and defined constraints may be defined such that there is no recursive/cyclical dependency between preferences settings such that an unambiguous order is always established regarding order in which settings may be evaluated and set/activated. It should be noted that an implementation may understand this ordering using the rend type fields but doesn't necessarily need to evaluate and activate the settings serially and could do optimizations to parallelize evaluation and activation of the settings as long as the ordering is obeyed.

In another embodiment a more generalized condition matching technique may be permitted for the condition where:
(1) the condition evaluates true if v(Sa) the current value of setting Sa is equal to a value V;
(2) the condition evaluates true if v(Sa) the current value of setting Sa is not equal to a value V;
(3) the condition evaluates true if v(Sa) the current value of setting Sa is greater than a value V;
(4) the condition evaluates true if v(Sa) the current value of setting Sa is less than a value V;
(5) the condition evaluates true if v(Sa) the current value of setting Sa is equal to any one of the values V1, V2, . . . Vn.

Other similar comparison or logical operation conditions may likewise be permitted.

In another embodiment Boolean expressions may be constructed based on multiple conditions. For example an expression consisting of individual expressions augmented with logical AND/OR/XOR/NOR/ etc. Boolean operations may be allowed to define a condition. For example following types of boolean expressions could be allowed:

Condition: (v(Sa)==V) && (v(Sp)!=K) (1)
where x && y indicates Boolean logical “and” of x and y

Condition: ((v(Sa)==V1)∥(v(Sp)==C)) && (v(Sz)>3)) (2)
where x && y indicates Boolean logical “and” of x and y,
where x∥y indicates Boolean logical “or” of x and y.

Former valid grammar syntax for the condition could be defined. An example Augmented Backus-Naur Form (ABNF) syntax is shown below for the case where only one condition is allowed, but may be extended to multiple conditions.

The syntax below is described using the Augmented Backus-Naur Form (ABNF) grammar defined in RFC 5234 (http://tools.ietf.org/html/rfc5234). Instead of a forward-slash “/” as in RFC 5234, the vertical bar symbol “|” is used to indicate alternatives. Rules are separated from definitions by an equal “=”, indentation is used to continue a rule definition over more than one line, literals are quoted with “”, parentheses “(” and “)” are used to group elements, optional elements are enclosed in “[” and “]” brackets, and elements may be preceded with <n>* to designate n or more repetitions of the following element; n defaults to 0.

condition = setting relOperator value
setting = “pref://” 1*8digit
relOperator = “==” | “!=” | “>” | “>=” | “<” | “<=”
value = decimalVal | charVal
charVal = *alphanum
decimalVal = [sign] 1*digit [“.” 1*digit]
sign = “+” / “%2B” / “−”
alphanum = alpha | digit
alpha = lalpha | ualpha
lalpha = “a” | “b” | “c” | “d” | “e” | “f” | “g” | “h” | “i” | “j” | “k” | “l”|
“m” | “n” | “o” | “p” | “q” | “r” | “s” | “t” | “u” | “v” | “w” | “x” | “y” |
“z”
ualpha = “A” | “B” | “C” | “D” | “E” | “F” | “G” | “H” | “I” | “J” | “K” |
“L” | “M” | “N” | “O” | “P” | “Q” | “R” | “S” | “T” | “U” | “V” | “W” |
“X” | “Y” | “Z”
digit = “0” | “1” | “2” | “3” | “4” | “5” | “6” | “7” | “8” | “9”

In an example embodiment the preference structure including conditions and other referred settings may be represented as shown in FIG. 10. As illustrated in FIG. 10, the preference including conditions and other referred settings may be represented in XML format. An example XML schema for the preference structure data fields of FIG. 10 is as follows:

```
<?xml version=“1.0” encoding=“UTF-8”?>
<xs:schema xmlns:xs=“http://www.w3.org/2001/XMLSchema” >
<xs:element name=“PrefStructTable” type=“PrefStructTableType” />
<xs:complexType name=“PrefStructTableType”>
<xs:sequence>
<xs:element name=“PrefStruct” type=“PrefStructType” minOccurs=“0”
maxOccurs=“unbounded”/>
</xs:sequence>
</xs:complexType>
<xs:complexType name=“PrefStructType”>
<xs:sequence>
                  <xs:element name=“id” type=“xs:anyURI”/>
                  <xs:element name=“relId” type=“IdArrType”
minOccurs=“0” maxOccurs=“unbounded”/>
                  <xs:element name=“cond” type=“xs:string”/>
                  <xs:element name=“si” type=“xs:string”/>
                                    <xs:element name=“pSi”
type=“StringArrType” minOccurs=“0” maxOccurs=“unbounded”/>
                  <xs:element name=“defSi” type=“xs:string”
minOccurs=“0” maxOccurs=“1”/>
</xs:sequence>
</xs:complexType>
<xs:simpleType name=“StringArrType”>
      <xs:list itemType=“xs:string”/>
</xs:simpleType>
<xs:simpleType name=“IdArrType”>
      <xs:list itemType=“xs:anyURI”/>
</xs:simpleType>
</xs:schema>
```

An example use case showing the use of proposed conditional preference evaluation and activation may be as follows: Alice prefers Spanish language audio track for her programs. When Spanish audio is available she does not want to see closed captions for her program. When Spanish audio is not available for her program she wants to see closed captions for her program as she is not fluent in other languages. In this case for the setting “audio track language” (setting Sa, with id[Sa]) Alice sets a preference (pSa[0]) of “Spanish” with no condition set for this preference structure. For the setting “closed caption On/Off” (setting Sb, with id[Sb]), setting for “audio track language” (setting Sa with id[Sa]) is set as related setting so that rend element in the preference structure of setting Sb lists id[Sa] with condition being checked as value not equal to “Spanish”. The preference value for “closed caption On/Off” is set equal to “On” if the condition is true. The default preference value for “closed caption On/Off” is set equal to “Off”. Thus in this case the XML data for preference structure Sb may look like following:

```
<?xml version=“1.0” encoding=“UTF-8”?>
<PrefStructTable
xmlns:xsi=“http://www.w3.org/2001/XMLSchema-instance”
        xsi:noNamespaceSchemaLocation=“accesspref1.xsd”>
      <PrefStruct>
            <id>id[Sb]</id>
            <relId>id[Sa]</relId>
            <cond>val(Sa)!=ESP</cond>
            <si>ClosedCaption</si>
            <pDataType>String</pDataType>
            <pSi>ON</pSi>
            <defSi>OFF</defSi>
            <Ordered>1</Ordered>
      </PrefStruct>
</PrefStructTable>
```

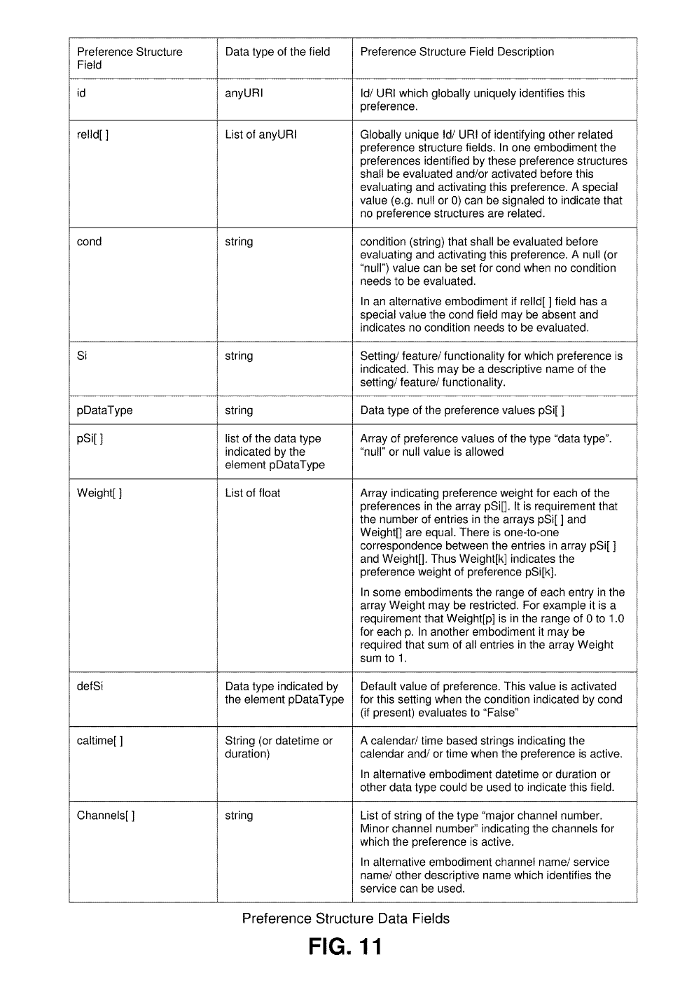

FIG. 11 illustrates an exemplary preference structure data fields. In this case various preference structure fields shown above are all included in the preference structure. An example XML schema for the preference structure data fields of FIG. 11 is as follows:

```
<?xml version=“1.0” encoding=“UTF-8”?>
<xs:schema xmlns:xs=“http://www.w3.org/2001/XMLSchema” >
<xs:element name=“PrefStructTable” type=“PrefStructTableType” />
<xs:complexType name=“PrefStructTableType”>
<xs:sequence>
<xs:element name=“PrefStruct” type=“PrefStructType” minOccurs=“0”
maxOccurs=“unbounded”/>
</xs:sequence>
</xs:complexType>
<xs:complexType name=“PrefStructType”>
<xs:sequence>
                  <xs:element name=“id” type=“xs:anyURI”/>
                  <xs:element name=“relId” type=“IdArrType”
minOccurs=“0” maxOccurs=“unbounded”/>
                  <xs:element name=“cond” type=“xs:string”/>
                  <xs:element name=“si” type=“xs:string”/>
                  <xs:element name=“pDataType” type=“xs:string”/>
                  <xs:element name=“pSi” type=“StringArrType”
minOccurs=“0” maxOccurs=“unbounded”/>
                  <xs:element name=“defSi” type=“xs:string”
minOccurs=“0” maxOccurs=“1”/>
                  <xs:element name=“Weight” type=“FloatArrType”
minOccurs=“0” maxOccurs=“unbounded”/>
                  <xs:element name=“caltime” type=“StringArrType”
minOccurs=“0” maxOccurs=“unbounded”/>
                  <xs:element name=“Channels”
type=“StringArrType” minOccurs=“0” maxOccurs=“unbounded”/>
</xs:sequence>
</xs:complexType>
<xs:simpleType name=“StringArrType”>
      <xs:list itemType=“xs:string”/>
</xs:simpleType>
<xs:simpleType name=“IdArrType”>
      <xs:list itemType=“xs:anyURI”/>
      </xs:simpleType>
<xs:simpleType name=“FloatArrType”>
      <xs:list itemType=“xs:float”/>
</xs:simpleType>
</xs:schema>
```

An example XML data conforming to the schema is shown next:

```
<?xml version=“1.0” encoding=“UTF-8”?>
<PrefStructTable
xmlns:xsi=“http://www.w3.org/2001/XMLSchema-instance”
        xsi:noNamespaceSchemaLocation=“accesspref1.xsd”>
      <PrefStruct>
            <id>pref://456</id>
            <relId>pref://123</relId>
            <cond>val(pref://123)!=ESP</cond>
            <si>ClosedCaption</si>
            <pDataType>String</pDataType>
            <pSi>ON</pSi>
            <defSi>OFF</defSi>
            <Weight>1</Weight>
            <caltime>ANY</caltime>
            <Channels>ANY</Channels>
      </PrefStruct>
</PrefStructTable>
```

Application Programming Interfaces (APIs) may be defined for runtime environment to access various preference settings defined as above.

A chkCond(iA) API may be defined:

chkCond(iA) checks the condition indicated by “cond” element of the preference structure with id equal to iA and returns True or False depending upon if the condition evaluates to true or false. The iA is id/URI which globally uniquely identifies the preference whose “cond” field is used for evaluation.

In one embodiment where one condition is allowed. The following sequenced steps may be taken by the runtime to evaluate the condition.
(1) For input parameter iA a preference structure table is checked to obtain PrefStruct[iA] with matching identifier iA. If PrefStruct[iA] is not found then an error may be indicated. For example an error “INVALID_ID” and a corresponding error code may be returned. Alternatively or additionally in this case the checkCond(iA) function may return False.
(2) The relId[ ] list in the identified PrefStruct[iA] is obtained. For each id idX in the list relId[ ], the preferences from PrefStruct of the idX is evaluated and activated. In another embodiment if those preferences from PrefStruct of the idX are not already evaluated and activated then and error may be indicated. For example an error “INCORRECT_ORDER” and a corresponding error code may be returned. Alternatively or additionally in this case the checkCond(iA) function may return False.
(3) The condition “cond” element in the identified PrefStruct[iA] is obtained. The cond element is checked against the grammar to check if the defined condition cond is valid according to the grammar. If the condition does not obey the grammar then an error is indicated. For example an error “INVALID_SYNTAX” and a corresponding error code may be returned. Alternatively or additionally in this case the checkCond(iA) function may return False.
(4) If the “cond” element is grammatically valid, the condition specified by cond element is evaluated using current value of the setting for each preference structure's in the condition. If the condition “cond” evaluates to true then checkCond(iA) function returns TRUE. If the condition “cond” evaluates to false then checkCond(iA) function returns FALSE.

Examples of grammar for “cond” element and further description of condition evaluation, and activation is provided previously.

In another embodiment following API can be defined:

A chkCond(cond) API may be defined:

Checks the condition indicated by “cond” input parameter and returns True or False depending upon if the condition evaluates to true or false. The cond field may have the same semantics as the “cond” field in the preference structure.

Additionally, for example, get and set APIs may be defined for each of the fields in the preference structure as follows:
getRelId(id): Returns the array of field relId[ ] for the preference structure with identifier equal to id
setRelId(id, rId[ ]): Set the array fields relId[ ] for the preference structure with identifier equal to id to the input array parameter rId[ ].
getcond(id): Returns the condition cond field for the preference structure with identifier equal to id
setcond(id, condition): Sets the condition field cond for the preference structure with identifier equal to id to the input parameter condition.
getDatatype(id): Returns the data type of “pDataType” field for the preference structure with identifier equal to id
setDatatype(id, dt): Sets the data type of field “pDataType” for the preference structure with identifier equal to id to the input parameter dt.
getWeight(id): Returns the array of field Weight[ ] for the preference structure with identifier equal to id
setWeight(id, wt[ ]): Sets the array of field Weight[ ] for the preference structure with identifier equal to id to the input array parameter wt [ ].
getPref(id): Returns the array of field pSi[ ] for the preference structure with identifier equal to id
setPref(id, pref[ ]): Set the array of field pSi[ ] for the preference structure with identifier equal to id to the input array parameter pref[ ].
getDefPref(id): Returns the value of field defSi for the preference structure with identifier equal to id
setDefPref(id, def): Sets the value of defSi field for the preference structure with identifier equal to id to the input parameter def.
getCaltime(id): Returns the array of field caltime[ ] for the preference structure with identifier equal to id
setCaltime(id, ct[ ]): Sets the array field caltime[ ] for the preference structure with identifier equal to id to the input array parameter ct[ ].
getChannels(id): Returns the array of field Channels[ ] for the preference structure with identifier equal to id
setChannels(id, sc[ ]): Sets the array field Channels[ ] for the preference structure with identifier equal to id to the input array parameter sc[ ].

As previously described, the preference structure data may be referred to as “accessibility preferences”. In another embodiment the preference structure data may be referred to as “rendering preferences”. In yet another embodiment the preference structure data may be referred to as “personalization preferences”. In yet another embodiment the preference structure data may be referred to as “content preferences”.

In one system accessibility preferences for a user may be characterized in a suitable manner for portability, such that the settings can be initially established on one receiving device and stored for reproduction of similar settings on any other receiving device. Receivers should support the storage of such accessibility preferences from multiple users. Thus in this case the defined preference structure may be stored using a standardized data format. In this case the preference structure defined above with various data fields may be stored in a standardized format such as XML, JSON, CSV (Comma separated values), binary form, etc.

In one embodiment the preference structure defined above with various data fields may be exchanged between one logical entity and another logical entity. In one case each of these entities may be a television set and/or a receiver. In one case one entity may be a primary device (PD) and the second entity may be a companion device (CD). In some case the logical entities may be same physical entity.

In one case the exchange of the preference structure defined above with various data fields may take place over network. In one case a set of defined APIs such as the APIs defined above may be used to exchange the preference structure defined above with various data fields.

In some embodiments the preference structure defined above with various data fields may be serialized. In one case the order of the fields in the preference structure defined above with various data fields may be maintained in the order specified above. In other cases the order may be changed with respect to each other.

In some embodiments the messages exchanged between two logical entities for the preference structure defined above with various data fields may require that the exchanged messages conform to the schema and/or structure defined above for the preference structure with various data fields.

Additional embodiments are now described related to targeting and/or demographics personalization data. Targeting and demographics personalization data involves determining user profile data and signaling content characteristics so that content can be filtered according to the user's profile.

ATSC A/105: 2015 describes a Interactive Services Standard which is incorporated here by reference. A105 describes the mechanisms and protocols that provide users of ATSC 2.0 system ways to personalize their local interactive experience. This is defined using Personalization, Demographics and Interested (PDI) data model and API. The data structure that encapsulates the questionnaire and the answers given by the particular user is called a PDI questionnaire or a PDI table.

Expiration related elements and attributes for personalization data fields are described next.

Various personalization data fields could be defined. Some default or standard data fields could be defined. Additionally content provider or broadcaster 300 could create and use custom data fields.

The default or Standard data fields could relate to accessibility and/or rendering preferences, emergency alert service preferences, etc. Examples of default personalization data fields include closed captioning preference, audio language preference, home location (e.g. zip code), television or receiver device capabilities, etc. Custom data fields allow content provider or broadcaster 300 to set specific personalization criteria that may be unique to different content provider or broadcaster 300. Custom data fields can have expiration related attributes after which the data field and any associated entries may be deleted from storage. The expiration related attributes may allow setting custom data fields to never expire or expire at a particular specified data/time or expire after a session (e.g. when TV is turned off) or when one or more other custom data field expires.

The value of an expiration attribute of a custom data field may be capable to be changed at anytime under user control.

Custom data fields may support extensibility. Default or standard data may also support extensibility. A standard mechanism for define or register new standard data fields may be defined.

Default/standard and custom data fields should allow personalization for multiple user identities.

Personalization data entries related to personalization data fields may be populated by several different mechanisms. In one case a user may be presented with a questionnaire asking the user to explicitly provide answers which will be used to populate personalization data entries for personalization data fields. These questions may be listed in a television receiver via a user interface or in an application or a web page. Also some of the personalization data fields may have default values set as the personalization data entry values. In the absence of user answer, these values could be used to populate the personalization data entries. In another case the receiver may observe past and current user behavior and automatically learn the user preferences. It may then user this inference to automatically populate the personalization data fields with personalization data entry values for a user. In yet another mode for populating the personalization data entries, a user may be allowed to share his/her personalization data entries with another user. Thus the personalization data entries for a user may be populated by copying those from personalization data entries from another user. An Application Programming Interface (API) may be provided to support this.

Personalization data entries can be associated with expiration related attributes at which time the entry may be deleted. In another case at expiration time the personalization data entry may be set back to a default value. The default value for a personalization data entry may be defined by a content provider or broadcaster 300. At the expiration time for a personalization data entry, the user may be asked for a renewal or change to the personalization data entry value explicitly. The user may be also allowed an option to auto renew one or more personalization entries when they expire. A user may be shown a reminder that a personalization data entry is about to expire sometime before it actually expires. The expiration related attributes may allow setting data entries to never expire or expire at a particular specified data/time or expire after a session (e.g. when TV is turned off) or when one or more other custom data field expires.

The value (data entry) of an expiration attribute of a custom data field may be capable to be changed at anytime under user control.

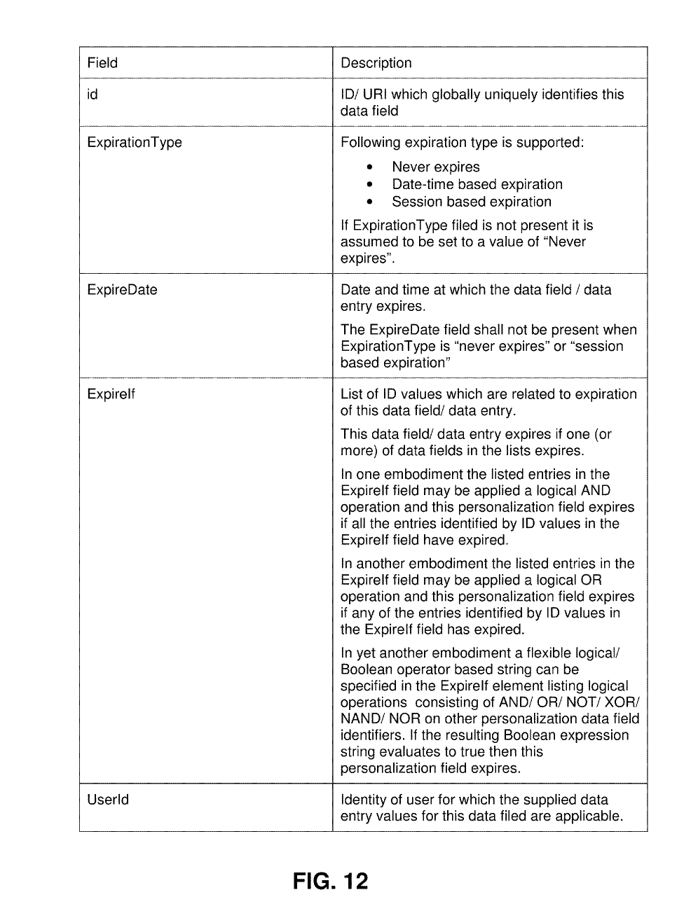

FIG. 12 shows example expiration attributes for targeting and demographics personalization data fields and data entries.

In FIG. 12 for personalization data fields and date entries expiration attributes are defined to support one or more of the following:
Session based expiration
Time duration based expiration
Linked expiration i.e. expiration of one data field based on expiration of one or more other data fields
No expiration (infinite expiration)

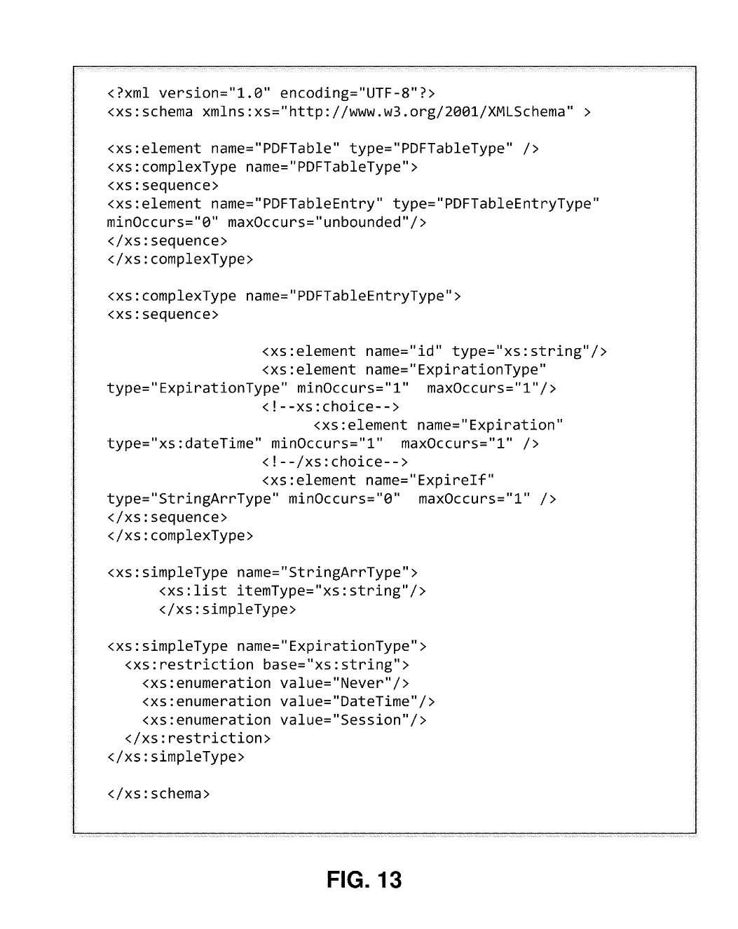

FIG. 13 shows an example XML schema for personalization data fields. In particular the fields related to expiration are shown in the XML schema.

In another embodiment, the id field may be represented with a data type of anyURI as shown below:
<xs:element name=“id” type=“xs:anyURI”/>

In another embodiment only some of elements related to expiration may be present simultaneously. Such restriction may be enforced by the use of <xs:choice>..</xs:choice> element in the schema.

In another embodiment some of the elements shown above may instead be represented as attributes. In another embodiment some of the attributes may instead be represented as elements. In yet another embodiment a JSON schema may be define using commonly known conventions.

In one embodiment sharing of personalization data fields and personalization data entries may be supported. This sharing may be under user control. Following types of sharing may be supported.

A user/viewer's personalization data fields and data entries can be shared across devices under user control. This allows a user to input their personalization data entries only once and carry it to multiple devices without repeatedly entering personalization data entries on each device.

A user/viewer can choose to share some or all of his/her personalization data fields and data entries with one or more other users. This allows members of household to copy each other's personalization data entries without explicitly entering those entires themselves.

As described previously application programming interface (API) may be defined to allow access to the personalization data fields and personalization data entries.

APIs can be defined for runtime environment to access expiration time related attributes of personalization data field. Also API can be defined to support sharing of personalization data.

Following APIs can be defined:

GetExpirationType(id): Returns the expiration type of personalization field identified with identifier equal to id. The returned value indicates the type of expiration as “Never”, “DateTime” or “Session”. An additional input parameter uid could be taken by the API indicating the user id for which the expiration type is to be retrieved.

SetExpirationType(id, eType): Set the expiration type of personalization field identified with identifier equal to id to a value specified by input parameter eType. The value of eType may be one of: “Never”, “DateTime” or “Session”. An additional input parameter uid could be taken by the API indicating the user id for which the expiration type is to be set.

GetExpirationIfId(id): Returns the array of IDs of personalization fields which are included in ExpireIf element as fields on whom the expiration of this personalization field is dependent. An additional input parameter uid could be taken by the API indicating the user id for which the ExpireIf element is to be retrieved.

SetExpirationIfId (id, ef[ ]): Set the array of ID s of personalization fields which are included in ExpireIf element of personalization field identified by id as fields on whom the expiration of this personalization field is dependent to the value specified in input parameter ef[ ]. An additional input parameter uid could be taken by the API indicating the user id for which the ExpireIf element is to be set.

GetExpirationDatetime(id): Returns the expiration date and time for the personalization field identified with identifier equal to id. An additional input parameter uid could be taken by the API indicating the user id for which the expiration date and time is to be retrieved.

SetExpirationDatetime(id,dt): Sets the expiration date and time for the personalization field identified with identifier equal to id to the value specified as input parameter dt. An additional input parameter uid could be taken by the API indicating the user id for which the expiration date and time is to be set.

GetPersFieldValue(uid,id): Returns the value (data entry) for personalization field identified with identifier equal to id for the user identified by user ID uid. The returned value is a String which encapsulates the data entry values.

SetPersFieldValue(uid,id,val): Set the value (Data entry) for personalization field identified with identifier equal to id for the user identified by user ID uid to a value specified by input parameter val. If a personalization field identified by the id value does not exist, it is created and its value is set. If the a personalization field identified by the id value exists then its value is changed to the value specified as input parameter val.

GetPersFieldIds(uid): Returns a list of identifiers for personalization data fields for the user identified by user ID uid. The returned value is a list of identifier values.

Additional system embodiments for the manner in which the defined personalization data fields and targeting and demographics preferences may be used as described next.

In one embodiment the personalization data fields may be called as “targeting preferences”. In another embodiment the preference structure data may be called as “demographics preferences”. In yet another embodiment the preference structure data may be called as “personalization preferences”.

In one system targeting and demographics preferences for a user may be characterized in a standard fashion for portability, such that the settings can be initially established on one receiving device and stored for reproduction of similar settings on any other receiving device. Receivers should support the storage of such targeting and demographics preferences from multiple users. Thus in this case the defined personalization data structure may be stored using a standardized data format. In this case the preference structure defined above with various data fields may be stored in a standardized format such as XML, JSON, CSV (Comma separated values), binary form etc.

In one embodiment the targeting and demographics preference structure defined above with various data fields may be exchanged from one logical entity and another logical entity. In one case each of these entities may be a Television set or a receiver. In one case one entity may be a primary device (PD) and the second entity may be a companion device (CD). In some case the logical entities may be same physical entity.

In one case the exchange of the targeting and demographics preferences data defined above with various data fields may take place over network. In some embodiment a set of defined APIs such at the APIs defined above may be used to exchange the preference structure defined above with various data fields.

In some embodiments the targeting and demographics preference data defined above with various data fields may be serialized. In one case the order of the fields in the targeting and demographics preference data defined above with various data fields may be maintained in the order specified above. In other cases the order may be changed with respect to each other.

In some embodiments the messages exchanged between two logical entities for the targeting and demographics preference data defined above with various data fields may require that the exchanged messages conform to the schema and/or structure defined above.

1. (canceled)

2. A method for decoding a data field in a bitstream comprising:
receiving custom data fields having an expiration related attribute, wherein the expiration related attribute indicates when the data field and any associated entries are deleted,
and a value of an expiration related attribute of a custom data field is capable to be changed at anytime under user control;
decoding the data field in the bitstream.

3. A method for decoding a data field in a bitstream comprising:
receiving personalization data fields and personalization data entries;
sharing the personalization data fields and the personalization data entries under user control;
decoding the data field in the bitstream.

4. The method of claim 3, wherein the personalization data fields and the personalization data entries, are across devices under user control.

5. The method of claim 3, wherein at least one of the personalization data fields and the personalization data entries is across other users under user control.
